(19) United States
(12) Patent Application Publication
(10) Pub. No.: US 2022/0410397 A1
(43) Pub. Date: Dec. 29, 2022

(54) System and Method for Robotic Calibration and Tuning

(71) Applicants: Biao Zhang, West Hartford, CT (US); ABB Schweiz AG, Baden (CH)

(72) Inventors: Biao Zhang, West Hartford, CT (US); Saumya Sharma, Hartford, CT (US); Yixin Liu, Houghton, MI (US); Jianjun Wang, West Hartford, CT (US); William J. Eakins, Coventry, CT (US); Andrew M. Salm, West Hartford, CT (US); Yun Hsuan Su, Seattle, WA (US); Jorge Vidal-Ribas, Esplugues de Llobregat (ES); Jordi Artigas, Barcelona (ES); Ramon Casanelles, Sant Cugat del Vellès (ES)

(73) Assignee: ABB Schweiz AG, Baden (CH)

(21) Appl. No.: 17/772,370

(22) PCT Filed: Oct. 29, 2019
(86) PCT No.: PCT/US2019/058541

§ 371 Date: Apr. 27, 2022

(51) Int. Cl. B25J 9/16

(52) U.S. Cl. CPC B25J 9/1692

(57) ABSTRACT

A system and method for use of artificial and nature racking features to calibrate sensors and tune a robotic control system of a sensor fusion guided robotic assembly. The artificial tracking features can have a configuration, or be at a location, that may be less susceptible to noise and error. Thus, the sensors can at least initially be calibrated, and the control system initially tuned, using the first tracking features until the sensors and control system satisfy operation performance criteria. Second tracking features, which may correspond to features on a workpiece that will be utilized in an assembly operation performed by the robot. By pre-calibrating the sensors, and pre-tuning the control system prior to calibration using the second tracking features, sensor calibration and system tuning based on the second tracking features can be attained faster and with less complexity.

### FIELD OF INVENTION

The present invention relates to robotic calibration and control system tuning, and more particularly, to a system and method for use of artificial and nature tracking features to calibrate sensors and tune a control system during set-up and optimization phases of a sensor fusion guided robotic assembly.

### BACKGROUND

A variety of operations can be performed during the final trim and assembly (FTA) stage of automotive assembly, including, for example, door assembly, cockpit assembly, and seat assembly, among other types of assemblies. Yet, for a variety of reasons, only a relatively small number of FTA tasks are typically automated. For example, often during the FTA stage, while an operator is performing an FTA operation, the vehicle(s) undergoing FTA is/are being transported on a line(s) that is/are moving the vehicle(s) in a relatively continuous stop and go manner. Yet such continuous stop and go motions of the vehicle(s) can cause or create certain irregularities with respect to at least the movement and/or position of the vehicle(s), and/or the portions of the vehicle(s) that are involved in the FTA. Moreover, such stop and go motion can cause the vehicle to be subjected to movement irregularities, vibrations, and balancing issues during FTA, which can prevent, or be adverse to, the ability to accurately model or predict the location of a particular part, portion, or area of the vehicle that directly involved in the FTA. Further, such movement irregularities can prevent the FTA from having a consistent degree of repeatability in terms of the movement and/or positioning of each vehicle, or its associated component, as each subsequent vehicle and/or component passes along the same area of the assembly line. Accordingly, such variances and concerns regarding repeatability can often preclude the use of traditional teach and repeat position based robot motion control in FTA operations.

Accordingly, although various robot control systems are available currently in the marketplace, further improvements are possible to provide a system and means to calibrate and tune the robot control system to accommodate such movement irregularities.

### BRIEF SUMMARY

An aspect of an embodiment of the present application is a method for calibrating sensors and tuning a control system used in guiding movement of a robot that is configured to perform an operation on a workpiece. The method can include pre-calibrating one or more sensors and pre-tuning the control system using a first tracking feature, and determining, after pre-calibrating and pre-tuning using the first tracking feature, whether the pre-calibrated one or more sensors and pre-tuned control system satisfy one or more operation performance criteria. The method can also include calibrating, if the pre-calibrated one or more sensors are determined to satisfy the one more operation performance criteria, the one or more pre-calibrated sensors using a second tracking feature, the second tracking feature being at a location that is more susceptible to noise than the first tracking feature. The method can also include calibrating, if the pre-tuned control system is determined to satisfy the one or more operation performance criteria, the pre-tuned control system using the second tracking feature, and determining whether the calibrated one or more sensors and tuned system satisfy the operation performance criteria.

Another aspect of an embodiment of the present application is a method for calibrating one or more sensors of a robotic system, the method including calibrating one or more sensors using a first tracking feature and determining, after calibrating using the first tracking feature, whether the calibrated one or more sensors satisfy operation performance criteria. The method can also include determining whether the calibrated one or more sensors and the tuned control system satisfy operation performance criteria using a second tracking feature, the second tracking feature being different than the first tracking feature. Additionally, the method can further include re-calibrating, if the calibrated one or more sensors do not satisfy the operation performance criteria, the calibrated one or more sensors using the second tracking feature, the second tracking feature being different than the first tracking feature, and re-tuning, if the tuned control system does not satisfy the operation performance criteria, the tuned control system using the second tracking feature.

Additionally, an aspect of an embodiment of the present application is a method comprising calibrating a plurality of sensors of a robot ulsing a first tracking feature, the first tracking feature being positioned on a first component within a robot station, and pre-tuning a control system using the first tracking feature. The method can also include determining, after calibrating and pre-tuning using the first tracking feature, whether the calibrated plurality of sensors satisfy a first calibration parameter. The method can also include determining whether the calibrated pluralitly of sensors and the pre-tuned control system satisfy an operation performance criteria. The method can also include re-calibrating the calibrated plurality of sensors and the pre-tuned control system using the second tracking feature, the second tracking feature being positioned on a second component in the robot station, and wherein the second tracking feature is different than the first tracking feature and the second component is different than the first component. Additionally, the method can include tracking, using at least one of the re-calibrated plurality of sensors, a movement of the second tracking feature.

These and other aspects of the present invention will be better understood in view of the drawings and following detailed description.

### BRIEF DESCRIPTION OF THE DRAWINGS

The description herein makes reference to the accompanying figures wherein like reference numerals refer to like parts throughout the several views.

FIG. 1 illustrates a schematic representation of at least a portion of an exemplary robotic system according to an illustrated embodiment of the present application.

FIG. 2 illustrates a schematic representation of an exemplary robot station through which vehicles are moved through by an automated or automatic guided vehicle (AGV), and which includes a robot that is mounted to a robot base that is moveable along, or by, a track.

FIG. 3 illustrates an exemplary first or artificial tracking feature that can be used in connection with at least initial calibration and tuning of robotic sensors and a robotic control system that can be involved in sensor fusion guided robotic movement.

FIG. 4 illustrates an exemplary second or nature tracking feature that can be used in connection with refining the calibration of at least pre-calibrated sensors that can be involved in sensor fusion guided robotic movement.

FIG. 5 illustrates an exemplary process for calibrating one or more sensors and tuning a robotic control system of a sensor fusion guided robot.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

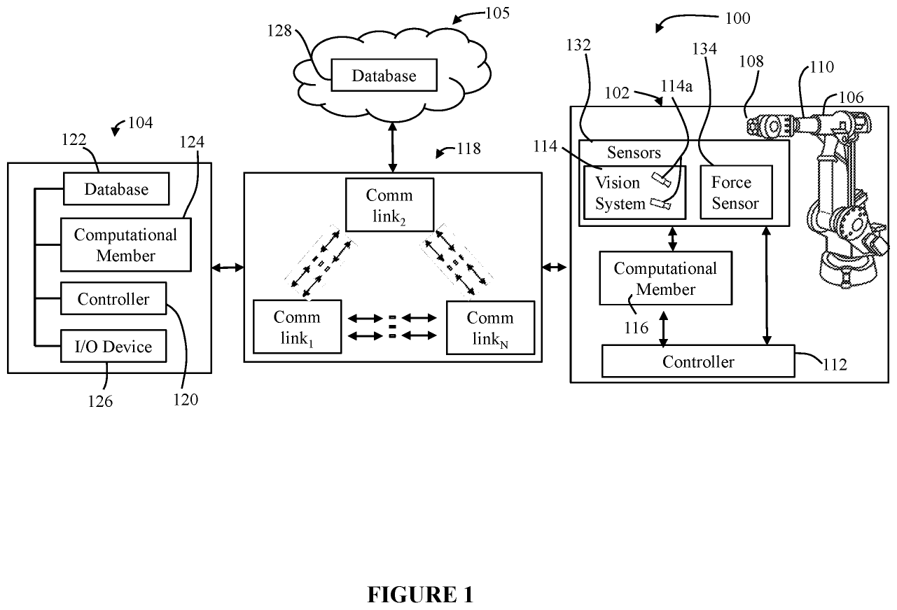

FIG. 1 illustrates at least a portion of an exemplary robotic system 100 that includes at least one robot station 102 that is communicatively coupled to at least one robotic control or robotic control system 104, such as, for example, via a communication network or link 118. The robotic control system 104 can be local or remote relative to the robot station 102. Further, according to certain embodiments, the robot station 102 can also include, or be in operable communication with, one or more supplemental database systems 105 via the communication network or link 118. The supplemental database system(s) 105 can have a variety of different configurations. For example, according to the illustrated embodiment, the supplemental database system(s) 105 can be, but is not limited to, a cloud based database.

According to certain embodiments, the robot station 102 includes one or more robots 106 having one or more degrees of freedom. For example, according to certain embodiments, the robot 106 can have, for example, six degrees of freedom. According to certain embodiments, an end effector 108 can be coupled or mounted to the robot 106. The end effector 108 can be a tool, part, and/or component that is mounted to a wrist or arm 110 of the robot 106. Further, at least portions of the wrist or arm 110 and/or the end effector 108 can be moveable relative to other portions of the robot 106 via operation of the robot 106 and/or the end effector 108, such for, example, by an operator of the robotic control system 104 and/or by programming that is executed to operate the robot 106.

The robot 106 can be operative to position and/or orient the end effector 108 at locations within the reach of a work envelope or workspace of the robot 106, which can accommodate the robot 106 in utilizing the end effector 108 to perform work, including, for example, grasp and hold one or more components, parts, packages, apparatuses, assemblies, or products, among other items (collectively referred to herein as “components”). A variety of different types of end effectors 108 can be utilized by the robot 106, including, for example, a tool that can grab, grasp, or otherwise selectively hold and release a component that is utilized in a final trim and assembly (FTA) operation during assembly of a vehicle, among other types of operations.

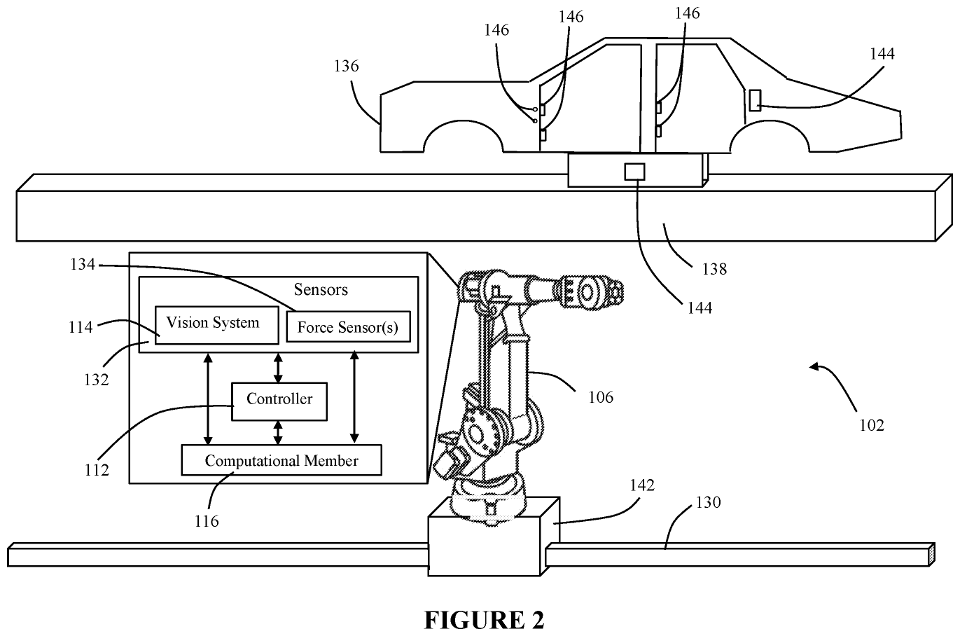

The robot 106 can include, or be electrically coupled to, one or more robotic controllers 112. For example, according to certain embodiments, the robot 106 can include and/or be electrically coupled to one or more controllers 112 that may, or may not, be discrete processing units, such as, for example, a single controller or any number of controllers. The controller 112 can be configured to provide a variety of functions, including, for example, be utilized in the selective delivery of electrical power to the robot 106, control of the movement and/or operations of the robot 106, and/or control the operation of other equipment that is mounted to the robot 106, including, for example, the end effector 108, and/or the operation of equipment not mounted to the robot 106 but which are an integral to the operation of the robot 106 and/or to equipment that is associated with the operation and/or movement of the robot 106. Moreover, according to certain embodiments, the controller 112 can be configured to dynamically control the movement of both the robot 106 itself, as well as the movement of other devices to which the robot 106 is mounted or coupled, including, for example, among other devices, movement of the robot 106 along, or, alternatively, by, a track 130 or mobile platform such as the AGV to which the robot 106 is mounted via a robot base 142, as shown in FIG. 2.

The controller 112 can take a variety of different forms, and can be configured to execute program instructions to perform tasks associated with operating the robot 106, including to operate the robot 106 to perform various functions, such as, for example, but not limited to, the tasks described herein, among other tasks. In one form, the controller(s) 112 is/are microprocessor based and the program instructions are in the form of software stored in one or more memories. Alternatively, one or more of the controllers 112 and the program instructions executed thereby can be in the form of any combination of software, firmware and hardware, including state machines, and can reflect the output of discreet devices and/or integrated circuits, which may be co-located at a particular location or distributed across more than one location, including any digital and/or analog devices configured to achieve the same or similar results as a processor-based controller executing software or firmware based instructions. Operations, instructions, and/or commands determined and/or transmitted from the controller 112 can be based on one or more models stored in non-transient computer readable media in a controller 112, other computer, and/or memory that is accessible or in electrical communication with the controller 112.

According to the illustrated embodiment, the controller 112 includes a data interface that can accept motion commands and provide actual motion data. For example, according to certain embodiments, the controller 112 can be communicatively coupled to a pendant, such as, for example, a teach pendant, that can be used to control at least certain operations of the robot 106 and/or the end effector 108.

The robot station 102 and/or the robot 106 can also include one or more sensors 132. The sensors 132 can include a variety of different types of sensors and/or combinations of different types of sensors, including, but not limited to, a vision system 114, force sensors 134, motion sensors, acceleration sensors, and/or depth sensors, among other types of sensors. Further, information provided by at least some of these sensors 132 can be integrated, including, for example, via use of algorithms, such that operations and/or movement, among other tasks, by the robot 106 can at least be guided via sensor fusion. Thus, as shown by at least FIGS. 1 and 2, information provided by the one or more sensors 132, such as, for example, a vision system 114 and force sensors 134, among other sensors 132, can be processed by a controller 120 and/or a computational member 124 of the robotic control system 104 such that the information provided by the different sensors 132 can be combined or integrated in a manner that can reduce the degree of uncertainty in the movement and/or performance of tasks by the robot 106.

The robot system 100 can include a wide range of parameters and settings that may need to be calibrated and/or tuned during at least initial set-up of the robot system 100 and/or initial set-up of the robot 106, as well as be further calibrated or refined during an optimization phase. For example, with respect to at least the robotic control system 104, such initial or pre-tuning, and subsequent refinement, or returning, of the initial tuning of the control system 104 can involve parameters relating to at least visual servoing, force control, robot motion, and sensor fusion, among other parameters. Such initial tuning, and subsequent refinement of the tuning, can assist the control system 104 in being able to satisfy certain operation performance criteria for the robot system 100 and/or the robot 106, including operation performance criteria relating to the movement and operation of the robot 106 in connection with operations and tasks that can be performed by the robot 106 in a production assembly operation.

Additionally, such initial set-up and subsequent optimization can also include initial or pre-calibrating, as well as subsequent refinement or re-calibration, of a variety of sensors 132, including, for example, calibration and subsequent refinement of the calibration of one or more cameras of the vision system 114 and force sensor 134, among other sensors 132. Further, each sensor 132 can have its own parameters that may need to be calibrated, and each part of the control system 106 may specific parameters that may need to be tuned, for at least purposes of stability of the robot system 100 and stability in the tasks and/or operations that are to be performed by the robot 106.

For example, the vision system 114 can be configured to process images captured by the vision system 114, as well as provide information from such image processing for visual servoing of the robot 106 by the robotic control system 104. With respect to image processing, the vision system 114 can be configured to search for certain tracking features within an image(s) that is captured by the vision system 114, and, from an identification of the tracking feature(s) in the captured image, determine position information for that tracking feature(s). Information relating to the determination of a location of a vision tracking in the captured image(s) can be sent to a visual servoing program of the control system 104 for tuning of the visual servoing. Further, the determined position information for the detected vision tracking feature(s) can be used to calibrate one or more sensors 132, such as, for example, a camera of the vision system 114.

As discussed below, a combination of first, artificial tracking features and second, natural tracking features can be utilized to improve the ease and reliability of the initial and subsequent optimization of the calibration of the sensors 132 and the tuning and subsequent refinement of the tuning of the control system 104. Moreover, at least initially, first artificial tracking features can be used for detection by one or more sensors 132. Such artificial tracking features can include features that are positioned or placed at one or more selected or particular locations on a component and/or in area that can generally be less susceptible to noise, such as, for example, noise associated with relatively low levels of light, movement irregularities, vibrations, and balancing issues, among other forms of noise. Accordingly, minimizing and/or generally eliminating noise that can adversely impact the ability to accurately detect and/or recognize the artificial tracking feature(s) can improve the ease and associated accuracy with which the artificial tracking feature(s) can be detected. Such improvements in the accuracy and ease of detection and recognition of the artificial tracking feature(s) can improve the reliability and accuracy of the associated information derived from the detected or recognized artificial tracking feature(s) that is used to at least initially calibrate, or pre-calibrate, one or more sensors 132 and/or initially tune, or pre-tune, the robotic control system 104.

The second, natural tracking features can include, but are not limited to, features of a component that will be located, contacted, moved, and/or identified during actual operation of the robot 106, such as, for example, actual tracking features of a component that the robot 106 is, or will be, handling, contacting, capturing an image of, and/or otherwise using during a production operation. However, unlike first, artificial tracking features in which the artificial tracking feature can be selectively positioned, or otherwise selected, based on an anticipated relatively low level of noise, the second, actual tracking features may be based on actual intended usage of the robot 106, such as, for example locating relatively small holes, contacting an area and/or part, and/or moving to a particular location, that may be inherently more susceptible to a relatively higher level of noise than the first, artificial tracking features. Such relatively higher levels of noise can adversely impact the reliability of the information obtained by the sensors 132 using the second, artificial tracking features, which can result in an increase in the uncertainty of determinations that are at least partially based on such obtained information. Accordingly, attempts to at least initially calibrate, or pre-calibrate, the sensors 132 and initially tune, or pre-tune the control system 104 using second, natural tracking features, rather than first, artificial tracking features, can, based on the associated relatively higher level of noise and uncertainty, result in a relatively broad range of parameters for both calibration of the sensors 132 and tuning of the system 104. Such broad ranges of parameters can result an in an increase in time and difficultly as the calibration of the sensors 132 and tuning of the system 104 are refined during subsequent optimization procedures.

Thus, although the second, natural tracking features may eventually be more utilized and/or desired for use during the actual production and/or assembly operation(s) or setting(s) in which the robot 106 is, or will, operate, such second, natural tracking features can, at least compared to the first, artificial n tracking features, be relatively more difficult to directly utilize in the initial calibration of the sensors 132 and the initial tuning of the control system 104. However, unlike second, natural tracking features, when using first, artificial tracking features during at least the initial calibration of the sensors 132 and initial tuning of the control system 104, the information obtained and/or processed, including, for example, image processing associated with processing features related to a first, artificial vision tracking feature(s) that is/are captured in the image(s), can provide a relatively reliable output to visual servoing. Moreover, the output provided by processing that utilizes the first, artificial tracking features, including, but not limited to information provided during at least initial tuning of the vision system 114, force sensors 134, and/or inertial measurement unit (IMU), among other types of sensors (collectively sensors 132), can provide a relatively narrower range of parameters than would be provided if initial calibration and initial tuning had relied on the second, natural tracking features. Such improvements in the reliability of the of the outputted information and decrease in the range of parameters improve the ease and reliability of subsequent refining of the calibration and tuning of the sensors 132 and control system 104, respectively. Additionally, with a narrower range of parameters, and subsequent refinement of the parameters, operators can also narrow down a range of parameters for the entire system 100. According to certain embodiments, following such refinement, the first, artificial tracking features can replaced by the second, natural tracking features, and fine tuning of the control system 104 and calibration of the sensors 132 can occur so as to achieve a relatively stable system that utilizes the second, natural tracking features.

According to the illustrated embodiment, the vision system 114 can comprise one or more vision devices 114a that can be used in connection with observing at least portions of the robot station 102, including, but not limited to, observing, parts, component, and/or vehicles, among other devices or components that can be positioned in, or are moving through or by at least a portion of, the robot station 102. For example, according to certain embodiments, the vision system 114 can extract information for a various types of visual features that are positioned or placed in the robot station 102, such as, for example, on a vehicle and/or on automated guided vehicle (AGV) that is moving the vehicle through the robot station 102, among other locations, and use such information, among other information, to at least assist in guiding the movement of the robot 106, movement of the robot 106 along a track 130 or mobile platform such as the AGV (FIG. 2) in the robot station 102, and/or movement of an end effector 108. Further, according to certain embodiments, the vision system 114 can be configured to attain and/or provide information regarding at a position, location, and/or orientation of one or more of the above-discussed first, artificial tracking features and/or the second, nature tracking features that can be used to calibrate the sensors 132 of the robot 106 and tune a robotic control system 104.

According to certain embodiments, the vision system 114 can have data processing capabilities that can process data or information obtained from the vision devices 114a that can be communicated to the controller 112. Alternatively, according to certain embodiments, the vision system 114 may not have data processing capabilities. Instead, according to certain embodiments, the vision system 114 can be electrically coupled to a computational member 116 of the robot station 102 that is adapted to process data or information outputted from the vision system 114. Additionally, according to certain embodiments, the vision system 114 can be operably coupled to a communication network or link 118, such that information outputted by the vision system 114 can be processed by a controller 120 and/or a computational member 124 of the robotic control system 104, as discussed below.

Examples of vision devices 114a of the vision system 114 can include, but are not limited to, one or more imaging capturing devices, such as, for example, one or more two-dimensional, three-dimensional, and/or RGB cameras that can be mounted within the robot station 102, including, for example, mounted generally above the working area of the robot 106, mounted to the robot 106, and/or on the end effector 108 of the robot 106, among other locations. Further, according to certain embodiments, the vision system 114 can be a position based or image based vision system 114. Additionally, according to certain embodiments, the vision system 114 can utilize kinematic control or dynamic control.

According to the illustrated embodiment, in addition to the vision system 114, the sensors 132 also include one or more force sensors 134. The force sensors 134 can, for example, be configured to sense contact force(s) during the assembly process, such as, for example, a contact force between the robot 106, the end effector 108, and/or a component being held by the robot 106 with the vehicle 136 and/or other component or structure within the robot station 102. Such information from the force sensor(s) 134 can be combined or integrated with information provided by the vision system 114, including for example, information derived in processing images that related to detection of the first and/or second vision tracking features, such that movement of the robot 106 during assembly of the vehicle 136 is guided at least in part by sensor fusion.

According to the exemplary embodiment depicted in FIG. 1, the robotic control system 104 can include at least one controller 120, a database 122, the computational member 124, and/or one or more input/output (I/O) devices 126. According to certain embodiments, the robotic control system 104 can be configured to provide an operator direct control of the robot 106, as well as to provide at least certain programming or other information to the robot station 102 and/or for the operation of the robot 106. Moreover, the robotic control system 104 can be structured to receive commands or other input information from an operator of the robot station 102 or of the robotic control system 104, including, for example, via commands generated via operation or selective engagement of/with an input/output device 126. Such commands via use of the input/output device 126 can include, but is not limited to, commands provided through the engagement or use of a microphone, keyboard, touch screen, joystick, stylus-type device, and/or a sensing device that can be operated, manipulated, and/or moved by the operator, among other input/output devices. Further, according to certain embodiments, the input/output device 126 can include one or more monitors and/or displays that can provide information to the operator, including, for, example, information relating to commands or instructions provided by the operator of the robotic control system 104, received/transmitted from/to the supplemental database system(s) 105 and/or the robot station 102, and/or notifications generated while the robot 102 is running (or attempting to run) a program or process. For example, according to certain embodiments, the input/output device 126 can display images, whether actual or virtual, as obtained, for example, via use of at least the vision device 114a of the vision system 114.

According to certain embodiments, the robotic control system 104 can include any type of computing device having a controller 120, such as, for example, a laptop, desktop computer, personal computer, programmable logic controller (PLC), or a mobile electronic device, among other computing devices, that includes a memory and a processor sufficient in size and operation to store and manipulate a database 122 and one or more applications for at least communicating with the robot station 102 via the communication network or link 118. In certain embodiments, the robotic control system 104 can include a connecting device that may communicate with the communication network or link 118 and/or robot station 102 via an Ethernet WAN/LAN connection, among other types of connections. In certain other embodiments, the robotic control system 104 can include a web server, or web portal, and can use the communication network or link 118 to communicate with the robot station 102 and/or the supplemental database system(s) 105 via the internet.

The robotic control system 104 can be located at a variety of locations relative to the robot station 102. For example, the robotic control system 104 can be in the same area as the robot station 102, the same room, a neighboring room, same building, same plant location, or, alternatively, at a remote location, relative to the robot station 102. Similarly, the supplemental database system(s) 105, if any, can also be located at a variety of locations relative to the robot station 102 and/or relative to the robotic control system 104. Thus, the communication network or link 118 can be structured, at least in part, based on the physical distances, if any, between the locations of the robot station 102, robotic control system 104, and/or supplemental database system(s) 105. According to the illustrated embodiment, the communication network or link 118 comprises one or more communication links 128 (Comm link_{1-N} in FIG. 1). Additionally, the system 100 can be operated to maintain a relatively reliable real-time communication link, via use of the communication network or link 118, between the robot station 102, robotic control system 104, and/or supplemental database system(s) 105. Thus, according to certain embodiments, the system 100 can change parameters of the communication link 128, including, for example, the selection of the utilized communication links 128, based on the currently available data rate and/or transmission time of the communication links 128.

The communication network or link 118 can be structured in a variety of different manners. For example, the communication network or link 118 between the robot station 102, robotic control system 104, and/or supplemental database system(s) 105 can be realized through the use of one or more of a variety of different types of communication technologies, including, but not limited to, via the use of fiber-optic, radio, cable, or wireless based technologies on similar or different types and layers of data protocols. For example, according to certain embodiments, the communication network or link 118 can utilize an Ethernet installation(s) with wireless local area network (WLAN), local area network (LAN), cellular data network, Bluetooth, ZigBee, point-to-point radio systems, laser-optical systems, and/or satellite communication links, among other wireless industrial links or communication protocols.

The database 122 of the robotic control system 104 and/or one or more databases 128 of the supplemental database system(s) 105 can include a variety of information that may be used in the identification of elements within the robot station 102 in which the robot 106 is operating. For example, as discussed below in more detail, one or more of the databases 122, 128 can include or store information that is used in the detection, interpretation, and/or deciphering of images or other information detected by a vision system 114, such as, for example, information related to the first, artificial tracking feature(s) and/or the second, nature tracking feature(s) that may be detected in the captured image(s). Additionally, or alternatively, such databases 122, 128 can include information pertaining to the one or more sensors 132, including, for example, information pertaining to forces, or a range of forces, that are to be expected to be detected by via use of the one or more force sensors 134 at one or more different locations in the robot station 102 and/or along the vehicle 136 at least as work is performed by the robot 106. Additionally, information in the databases 122, 128 can also include information used to at least initially calibrate the one or more sensors 132, including, for example, first calibration parameters associated with first tracking features and second calibration parameters that are associated with second tracking features, as well as parameters relating to the operation and tuning of the control system 104.

The database 122 of the robotic control system 104 and/or one or more databases 128 of the supplemental database system(s) 105 can also include information that can assist in discerning other features within the robot station 102. For example, images that are captured by the one or more vision devices 114a of the vision system 114 can be used in identifying, via use of information from the database 122, FTA components within the robot station 102, including FTA components that are within a picking bin, among other components, that may be used by the robot 106 in performing FTA.

FIG. 2 illustrates a schematic representation of an exemplary robot station 102 through which vehicles 136 are moved by an automated or automatic guided vehicle (AGV) 138, and which includes a robot 106 that is mounted to a robot base 142 that is moveable along, or by, a track 130 or mobile platform such as the AGV. While for at least purposes of illustration, the exemplary robot station 102 depicted in FIG. 2 is shown as having, or being in proximity to, a vehicle 136 and associated AGV 138, the robot station 102 can have a variety of other arrangements and elements, and can be used in a variety of other manufacturing, assembly, and/or automation processes. Further, while the depicted robot station 102 can be associated with an initial set-up of a robot 106, the station 102 can also be associated with use of the robot 106 in an assembly and/or production process.

Additionally, while the example depicted in FIG. 1 illustrates a single robot station 102, according to other embodiments, the robot station 102 can include a plurality of robot stations 102, each station 102 having one or more robots 106. The illustrated robot station 102 can also include, or by operated in connection with, one or more AGV 138, supply lines or conveyors, induction conveyors, and/or one or more sorter conveyors. According to the illustrated embodiment, the AGV 138 can be positioned and operated relative to the one or more robot stations 102 so as to transport, for example, vehicles 136 that can receive, or otherwise be assembled with or to include, one or more components of the vehicle(s) 136, including, for example, a door assembly, a cockpit assembly, and a seat assembly, among other types of assemblies and components. Similarly, according to the illustrated embodiment, the track 130 can be positioned and operated relative to the one or more robots 106 so as to facilitate assembly by the robot(s) 106 of components to the vehicle(s) 136 that is/are being moved via the AGV 138. Moreover, the track 130 or mobile platform such as the AGV, robot base 142, and/or robot can be operated such that the robot 106 is moved in a manner that at least generally follows of the movement of the AGV 138, and thus the movement of the vehicle(s) 136 that are on the AGV 138. Further, as previously mentioned, such movement of the robot 106 can also include movement that is guided, at least in part, by information provided by the one or more force sensor(s) 134.

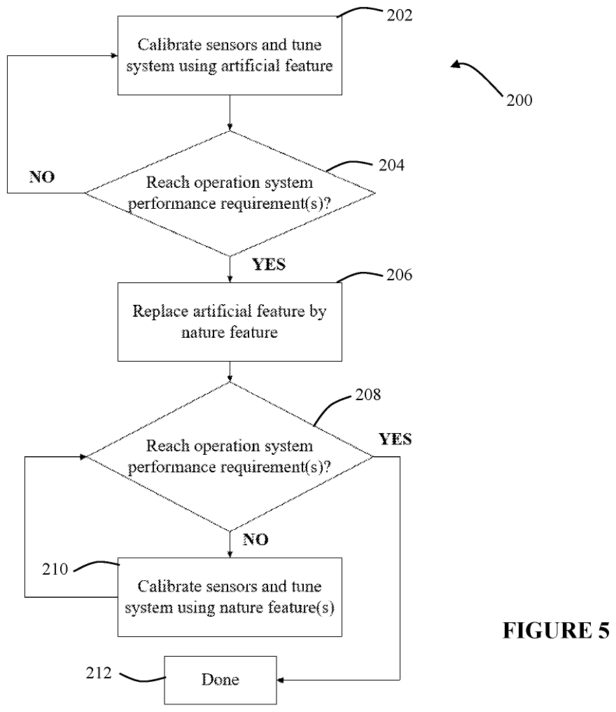

FIG. 5 illustrates an exemplary process 200 for calibrating one or more sensors 132 and tuning a robotic control system 104 of a sensor fusion guided robot 106. The operations illustrated for all of the processes in the present application are understood to be examples only, and operations may be combined or divided, and added or removed, as well as re-ordered in whole or in part, unless explicitly stated to the contrary. Further, while the process 200 discussed herein can be utilized at a variety of different time periods during the lifetime or and/or stages of operation of the robot 106, and/or in a variety of different settings, according to certain embodiments the process 200 can be used at least during the initial set-up and/or optimization phases of a sensor fusion guided robot 106, and moreover, prior to the robot 106 being utilized in an assembly or manufacturing line, operation, or application.

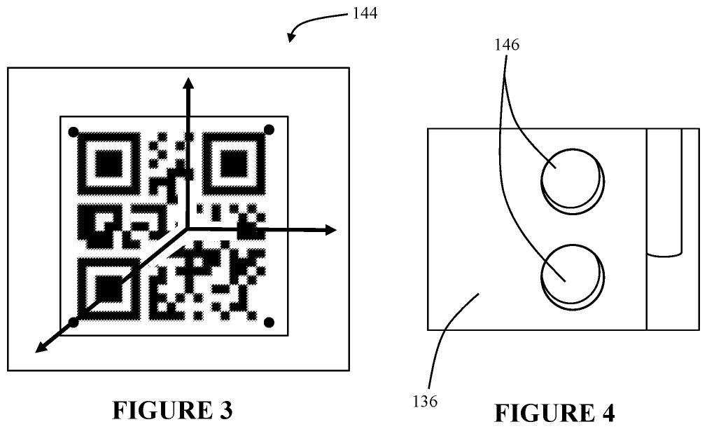

As shown in FIG. 5, at step 202, the sensors 132 can at least initially be calibrated, and the control system 104 can be at least initially tuned, using one or more first tracking features 144 (FIGS. 2 and 3). The first tracking features 144 can have a configuration, or be at a location, that may be less susceptible to noise, and moreover less susceptible to high noise, and error than other types of second tracking features 146 (FIGS. 2 and 4) that, as discussed below, can subsequently be utilized in refining the calibration of the sensors 132 and tuning of the control system 104. Thus, according to certain embodiments, the first tracking features 144, also referred to herein as artificial features, can be features that are configured and/or at a location in the robot station 102 that may be less susceptible to noise, including, for example, noise associated with lighting, movement irregularities, vibrations, and balancing issues, than other, second tracking features 146. Thus according to certain embodiments, while the second tracking feature(s) 146 may relate to feature(s) that the sensors 132 will eventually track, engage, or otherwise utilize in the assembly operation that the robot 106 is being programmed or trained to perform, the first tracking features 144 can be features that are utilized to at least initially calibrate the sensors 132 to satisfy a relatively narrow range of first calibration parameters. As discussed below, the calibration of the sensors 132 can subsequently be further refined such that the calibrated sensors 132 satisfy an even narrower range of second calibration parameters.

Thus, for example, according to certain embodiments, such first tracking features 144 can include, but are not limited to, items that are configured and/or position primarily for use in initial calibration of the sensors 132 and initial tuning of the control system 104. For example, according to certain embodiments, the first tracking features 144 can be features that include a quick response (QR) code, as shown, for example, in FIG. 3. However, a variety of other types of images or visual indicators can be utilized for the first tracking feature 144 in connection with at least the initial calibration of the sensors 132, including, for example the vision system 114, force sensors 134, and initial tuning of the control system 104, including, for example, initial tuning of the visual servoing, sensor fusion, robotic force control, and robot motion. For example, according to certain embodiments, the first vision tracking features can also include, but is not limited to, two dimensional QR codes. Alternatively, or additionally, the first tracking feature 144 can be a portion of the vehicle 136 or workpiece, or related component, which is at a location that is generally less susceptible to noise, including noise associated with movement caused by natural forces, than other portions of the vehicle 136 or workpiece.

Further, in addition to tracking features, at least initial calibration using a first nature feature can involve comparing sensed information with known information. For example, with respect to force sensors 134, when the robot 106 is at a particular location(s), or moving in a particular direction(s), the force(s) detected by the force sensor(s) 134 at that known location(s) or direction(s) can be compared to a known force measurement(s) for that location(s) or direction(s).

The first tracking feature 144 can be used to calibrate a variety of different types of sensors 132. For example, as previously discussed, with respect to the vision system 114, a first tracking feature can be a visual feature that is at a location that is generally less susceptible to noise that may otherwise adversely impact at least the accuracy of the image(s) captured by the vision system 114 and/or the associated information processed from such an image. Additionally, the first tracking feature can be positioned so that the first tracking feature, when at least compared to the second tracking feature, may be at a relatively static location, or be generally static relative to at least the robot 106, such that, at least during initial calibration and related tuning associated with the force sensors 134, the information obtained by the force sensors 134 may not be adversely impacted by unintended or natural movement and/or vibration of the part that the robot 106 is contacting for at least calibration and tuning purposes. Further, for example, the same first tracking feature 144 can be used for calibrating multiple types of sensors 134, including, for example, both the vision system 114 and the force sensor(s) 134, among other sensors. For example, according to certain embodiments, the first tracking feature 144 can include an image associated with calibration of the vision system 114 and be at a location that is used in connection with contact by the robot 106 in connection with calibration of the force sensor 134.

As previously discussed, the first tracking feature 144 can be at a variety of locations about the robot station 102. For example, as shown in FIG. 5, according to certain embodiments, a first tracking feature 144 can be positioned on the AGV 138, including, for example, on a portion of the AGV 138 that is beneath, and which is moving along with, the vehicle 136. Additionally, or alternatively, according to certain embodiments, the first tracking feature 144 can be located on a portion of the vehicle 136 that is not directly involved in the assembly operation for which the robot 106 is being set up, and/or optimized to perform. For example, according to certain embodiments, while the robot 106 may be in the process of being programmed for eventual use in a FTA assembly operation in which the robot 106 may need to locate and align holes around a door opening or door post in a vehicle 136, the first tracking feature 144 may be at, or mounted to, some other portion of the vehicle 136, such as, for example a portion of a rear roof post.

At step 204, a determination can be made, such as, for example, by the controller 112, as to whether the initial calibration of the sensors 132 and initial tuning of the control system 104 via use of the first tracking feature(s) 144 has satisfied operational program criteria. Such operational program requirements can, for example, be predetermined and stored in a memory that is accessible to, or in electrical communication with, the controller 112. Further, satisfaction of such operational program requirements can be evaluated based on information provided by each sensor or sensor type, and/or can be based on an evaluation(s) of the movement of the robot 106, including, for example, a time duration, speed, path of travel, contact force, and accuracy with respect to certain movements and/or operations performed by the robot 106, including movement of the robot 106 as guided by sensor fusion, that is based on the current degree of calibration of the sensors 132 and/or degree of tuning of the control system 104. Thus, for example, according to certain illustrated embodiments, a determination as to whether the operational program requirements have been satisfied can be based, at least in part, on a value(s) of a force sensed by the force sensor 134 being within a predetermined parameter range or satisfying a predetermined parameter threshold, the degree of errors, if any, in the movement of the robot 106 when using the vision system 114, and/or the accuracy in the movement of the robot 106 when guided using information provided by a plurality of the sensors 132, such as, for example, when using combined or integrated information from at least the force sensors 134 and the vision system 114, among other sensors.

Further, as previously discussed, the parameters associated with the initial calibration of the sensors 132, as well as the initial tuning of the control system 104, that is associated with use of the first, artificial tracking features 146 can, according to certain embodiments, be broader than parameters associated with further or additional refinement in both the calibration of the sensors 132 and tuning of the control system 104 when subsequently using the second, nature tracking features 146.

If, at step 204, it is determined, such as, for example, by the controller 112, that, with the initial calibration of the sensors 132 and/or initial tuning of the control system 104, the operational program requirements are not satisfied then the process 200 can continue with initial calibration of the sensors 132 and tuning of the control system 104 at step 202 via use of the first tracking features 144. For example, if at step 204 it is determined that r that the movement of the robot 106, as guided by sensor fusion, does not have a requisite degree of accuracy, and or contact force by the robot 106 does not satisfy a force threshold or range, then the process 200 can continue with the initial calibration of the sensors 132 and tuning of the control system 104 at step 202 via use of the first tracking features 144.

However, if at step 204 it is determined that the operational program requirements are satisfied, then at step 206, the first tracking features 144 can be replaced with the second tracking features 146. As previously discussed, compared to first tracking features 144, the second tracking features 146 can be features on or in the vehicle 136 that are directly involved or utilized in the assembly process that is to be performed using the robot 106. For example, according to certain embodiments, the second tracking features 146 can be one or more holes (FIGS. 2 and 4) that are to receive insertion of a component or a portion of a component, such as, for example, a mounting post, and/or a mechanical fastener, such as, for example, bolt, pin, screw, while the robot 106 is performing an assembly process, including, for example, an FTA operation.

As the second tracking features 146 can be portions of the vehicle 136 that are directly involved in at least some aspect of the assembly process that will be performed by the robot 106, there may not be the same degree of freedom or flexibility in choosing the second tracking features 146 as there can be in selecting the first tracking features 144. Thus, unlike the first calibration features, calibration using the second tracking features 146 can involve portions of the vehicle 136, or related components, that have a size, configuration, position, number, and/or movement, as well as any combination thereof, among other factors, that can be more susceptible to noise, and thus can present a higher degree of difficulty and uncertainty relating to calibrating the sensors 132 and tuning the control system 104. Such difficulties can include increased challenges presented by noise associated with lighting, vibrations, and movement, among other noise and forms of errors. For example, a second tracking feature 146 can be one or more holes that are sized, positioned, and/or oriented in a manner that creates potential issues with the system 114 capturing a clear image of the second tracking feature 146 and/or at a location that is susceptible to a relatively high degree of vibration and/or irregular movement. Moreover, in such situations, the second calibration feature 146 may receive too much, or too little, light, or vibrate in a manner that causes pixilation issues in the image(s) captured by the vision system 114 and/or cause the component being contacted by the robot 106 to be moving in a matter that results in the force sensors 134 obtaining relatively inaccurate, unreliable, and/or a broad range of information. With respect to captured images, such pixilation can create difficulties in the robot 102 accurately detecting, or detecting with a desired degree of precision, the location and/or boundaries of the second tracking feature 146, thus further complicating the calibration and tuning processes using the second tracking feature 146. Similarly, the information obtained by the force sensors 134 from an object that is moving irregularly can also complicate the reliability and duration of calibration and tuning of the robot 106. However, the process 200 discussed herein can reduce or minimize such complexity and time associated with calibration and tuning using the second, nature tracking features 146, as the sensors 132 are already pre-calibrated and the control system 104 has been pre-tuned via the initial calibration and tuning at step 202 and the subsequent determination at step 204 that the initially calibrated sensors 132 and initially tuned control system 104 satisfied the operational program requirements. Thus, according to the illustrated embodiment, calibration and associated tuning based on use of the second tracking features 146 can involve the refinement in the calibration and tuning of the already well-calibrated sensors 132 and well-tuned control system 104. Such refinement in calibration and tuning can involve, for example, further narrowing, if necessary, of parameters to satisfy an even smaller range of level of parameters that are associated with the second tracking features 146. However, by already initially calibration and tuning the sensors 132 and control system 104 using the first, artificial tracking features 144 to satisfy certain requirements prior to further refinement, such a process 200 not only can decrease the complexity and time associated with calibrating the sensors 132 and tuning the control system 104 to satisfy parameters associated with the second tracking features 146, but can also lead to a more accurate calibration and tuning than if calibration and tuning were instead based directly on the second tracking features 146 without the benefit of the first tracking features 144. Further, such improved accuracy in the calibration of the sensors 132 and tuning of the control system 104 can lead to a more reliable and stable operation of the robot 106, including the sensor fusion guided movement of the robot 106.

At step 208, the process 200 can determine if the calibration and tuning attained in connection when using the first, artificial tracking features at step 204 also satisfies the operation performance criteria when the first, artificial tracking features are replaced by the second, tracking features are used. If the calibration of the sensors 132 and tuning of the control system attained at step 202 still satisfies the operation performance criteria when the second, tracking features are used in connection with the operation of the robot 106, then the calibration and tuning process 200 can conclude at step 212. If, however, further refinement of the initial calibration and initial tuning is needed, then at step 210, both the calibration of the sensors 132 and the tuning of the control system 104 can undergo further refinement. Such refinement in calibration and tuning can continue until a determination is made at step 208, such as, for example, by the controller 112, that the sensors 132 have been calibrated, and the control system 104 has been tuned, in a manner that satisfies the operation performance criteria when the robot 106 is operated in connection with at least use of the second, nature tracking features. Upon a determination that the calibration and tuning of the sensors 132 the control system 104 have been refined to a degree that satisfies the operation performance criteria, the calibration process 200 can proceed to step 212, wherein the calibration and tuning process 200 is concluded.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. A method for calibrating sensors and tuning a control system used in guiding movement of a robot that is configured to perform an operation on a workpiece, the method comprising:
pre-calibrating one or more sensors using a first tracking feature;
pre-tuning the control system using the first tracking feature;
determining, after pre-calibrating and pre-tuning using the first tracking feature, whether the pre-calibrated one or more sensors and the pre-tuned control system satisfy one or more operation performance criteria;
calibrating, if the pre-calibrated one or more sensors are determined to satisfy the one or more operation performance requirements, the one or more pre-calibrated sensors using a second tracking feature, the second tracking feature being at a location that is more susceptible to noise than the first tracking feature;
calibrating, if the pre-tuned control system is determined to satisfy the one or more operation performance criteria, the pre-tuned control system using the second tracking feature; and
determining whether the calibrated one or more sensors and the tuned control system satisfy the one or more operation performance criteria.

2. The method of claim 1, wherein the one or more sensors includes at least one vision system and at least one force sensor, the first tracking being at a location at which the robot will not be performing an operation on the workpiece.

3. The method of claim 2, wherein the first tracking feature is positioned on the workpiece.

4. The method of claim 2, wherein the first tracking feature is not positioned on the workpiece.

5. The method of claim 4, wherein the second tracking feature is positioned on the workpiece.

6. The method of claim 5, wherein the first tracking feature is on an automated guided vehicle that moves the workpiece.

7. The method of claim 6, further including the step of securing a component to the workpiece at the second tracking feature.

8. A method for calibrating one or more sensors and tuning a control system of a robotic system, the method comprising:
calibrating one or more sensors using a first tracking feature;
tuning control system using the first tracking feature;
determining, after calibrating and tuning using the first tracking feature, whether the calibrated one or more sensors and tuned control system satisfy operation performance criteria;
determining, whether the calibrated one or more sensors and tuned control system satisfy operation performance criteria using a second tracking feature;
re-calibrating, if the calibrated one or more sensors do not satisfy the operation performance criteria, the calibrated one or more sensors using a second tracking feature, the second tracking feature being different than the first tracking feature; and
re-tuning, if the tuned control system does not satisfy the operation performance criteria, the tuned control system using the second tracking feature.

9. The method of claim 8, further including the step of tracking the second tracking feature as a workpiece having the second tracking feature is displaced.

10. The method of claim 9, further including the step of displacing a robot of the robotic system at least in a direction of displacement of the second tracking feature as the second tracking feature is displaced.

11. The method of claim 8, further including the step of guiding, after the one or more sensors are determined to satisfy the second tracking feature, movement of a robot of the robotic system using information from a plurality of the one or more sensors.

12. The method of claim 8, wherein the first tracking feature is positioned on an automatic guided vehicle and the second tracking feature is positioned on a vehicle that is positioned on the automatic guided vehicle.

13. The method of claim 12, further including the step of assembling, after the calibrated one or more sensors and the tuned control system are determined to satisfy the operation performancecriteria, a component to the second tracking feature.

14. The method of claim 13, wherein the first tracking feature comprises a quick release code.

15. The method of claim 14, wherein the second tracking feature comprises one or more holes in the vehicle.

16. A method comprising:
calibrating a plurality of sensors of a robot using a first tracking feature, the first tracking feature being positioned on a first component within a robot station;
pre-tuning a control system using the first tracking feature;
determining, after calibrating and pre-tuning using the first tracking feature, whether the calibrated plurality of sensors and the pre-tuned control system satisfy an operation performance criteria;
determining whether the calibrated plurality of sensors and the pre-tuned control system satisfy the operation performance criteria using a second tracking feature;
re-calibrating the calibrated plurality of sensors and tuning the pre-tuned control system using the second tracking feature, the second tracking feature positioned on a second component in the robot station, the second tracking feature being different than the first tracking feature and the second component being different than the first component; and
tracking, using at least one of the re-calibrated plurality of sensors, a movement of the second tracking feature.

17. The method of claim 16, further including the steps of determining whether the re-calibrated plurality of sensors and the tuned control system satisfy the operation performance criteria, and of guiding movement of the robot using information from two or more of the re-calibrated plurality of sensors.

18. The method of claim 17, further including the step of assembling, using the guided movement of the robot and after the re-calibrated plurality of sensors and the tuned control system are determined to satisfy the operation performance criteria, a third component to the second tracking feature.

19. The method of claim 18, wherein the plurality of sensors includes a vision system and at least one force sensor.

20. The method of claim 19, wherein the first tracking feature comprises a quick release code and the second tracking feature comprises a hole in the second component.
